(19) United States
(12) Patent Application Publication
(10) Pub. No.: US 2005/0112949 A1
(43) Pub. Date: May 26, 2005

(54) Electric connector for board-to-board connection

(76) Inventor: Peter Huang, Taipei (TW)

Correspondence Address: LAW OFFICES OF DAVID PAI, 1001 FOURTH AVENUE, SUITE 3200, SEATTLE, WA, 98154, US

(21) Appl. No.: 10/717,740

(22) Filed: Nov. 20, 2003

(51) Int. Cl. H01R 24/00

(52) U.S. Cl. 439/637

(57) ABSTRACT

An electric connector for board-to-board connection formed of an electrically insulative housing and a set of terminals installed in the housing is disclosed and claimed in which the housing has a plurality of recessed retaining holes in the bottom wall thereof adapted to receive respective protruding positioning portions of the terminals for improved positioning of the terminals in the housing without deforming the plastic material of the housing.

### BACKGROUND OF THE INVENTION

1. Field of the Invention

The present invention relates to electric connectors and, more particularly, to an electric connector for board-to-board connection.

2. Description of the Related Art

FIGS. 1-4 show a female connector member for an electric connector for board-to-board connection according to the prior art. This structure of female connector comprises an elongated electrically insulative housing 8 molded from plastics, and a plurality of terminals 9 mounted in the housing 8. The housing 8 has a first sidewall 81, a second sidewall 82, a bottom wall 83, a recessed receiving portion 84 surrounded by the sidewalls 81 and 82 and the bottom wall 83 and adapted to accommodate the male connector member of the electric connector for board-to-board connection, and a plurality of terminal slots 85 cut through the bottom wall 83 and extended to the sidewalls 81 and 82. The terminals 9 are respectively mounted in the terminal slots 85, each having a contact end 91 extended to one sidewall 81 or 82 and facing the recessed receiving portion 84, a bonding end 92 downwardly extended out of the bottom wall 83 for soldering to a circuit board (not shown), and a protruding positioning portion 93 suspended below the contact end 91 and projecting toward the recessed receiving portion 84. When a terminal 9 is inserted into a terminal slot 85 in the housing 8 from the bottom side, the protruding positioning portion 93 is forced into engagement with the bottom wall 83 to fix the respective terminal 9 in position (see FIG. 3). However, when forcing the protruding positioning portion 93 of one terminal 9 into engagement with the bottom wall 83, the hard metal material of the respective terminal 9 will deform the plastic material of the housing around the protruding positioning portion 93, thereby causing a protruding portion 86 to be formed in the bottom wall 83 around the protruding positioning portion 93 toward the recessed receiving portion 84 (see FIG. 4). After installation of all terminals 9 in the housing 8, the protruding portions 86 thus formed in the housing 8 will affect stable connection between the male connector member and the female connector member.

### BRIEF SUMMARY OF THE INVENTION

The present invention has been accomplished under the circumstances in view. It is the main object of the present invention to provide an electric connector for board-to-board connector, which prevents material deformation during installation and, enhances the structural strength for improved connection between the boards.

To achieve this and other objects of the present invention, the electric connector comprises an electrically insulative housing, the electrically insulative housing comprising a first sidewall, a second sidewall, a bottom wall connected to the first sidewall and the second sidewall at a bottom side, a recessed receiving portion surrounded by the sidewalls and the bottom wall and adapted to accommodate a matching connector, and a plurality of terminal slots, each of which is cut through the bottom wall and extended to either the first sidewall or the second sidewall; and a plurality of terminals respectively mounted in the terminal slots, the terminals each having a contact end extended to either the first sidewall or the second sidewall and facing the recessed receiving portion, a bonding end downwardly extended out of the bottom wall for soldering to a circuit board, and a protruding positioning portion suspended below the contact end and projecting toward the recessed receiving portion for positioning in the bottom wall of the housing; wherein the housing has a plurality of recessed retaining holes in the bottom wall adapted to receive the protruding positioning portions of the terminals.

### BRIEF DESCRIPTION OF THE DRAWINGS

FIG. 1 is a perspective view of a female connector member for an electric connector for board-to-board connection according to the prior art.

FIG. 2 is a top view in an enlarged scale of a part of the housing of the female connector member shown in FIG. 1.

FIG. 3 is a sectional view taken along line A-A of FIG. 2.

FIG. 4 is a sectional assembly view of FIG. 3.

FIG. 5 is a top view of an electrically insulative housing for an electric connector for board-to-board connection according to the present invention.

FIG. 6 is a sectional view taken along line B-B of FIG. 5.

FIG. 7 is a sectional assembly view of FIG. 6.

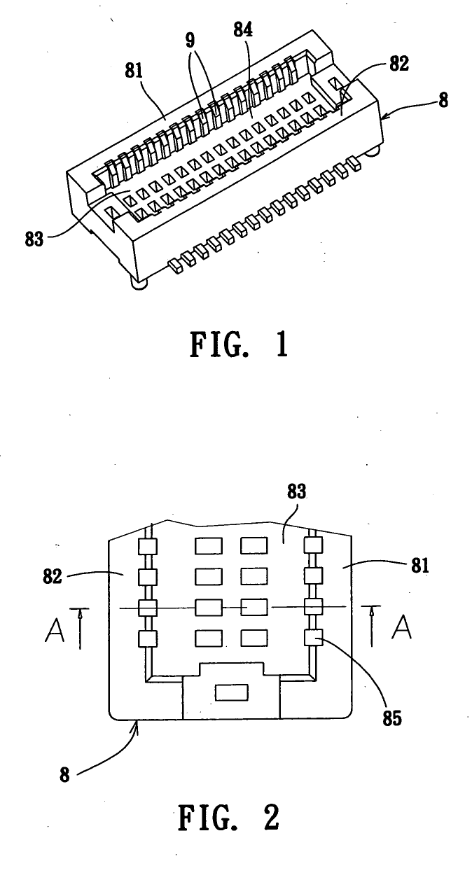

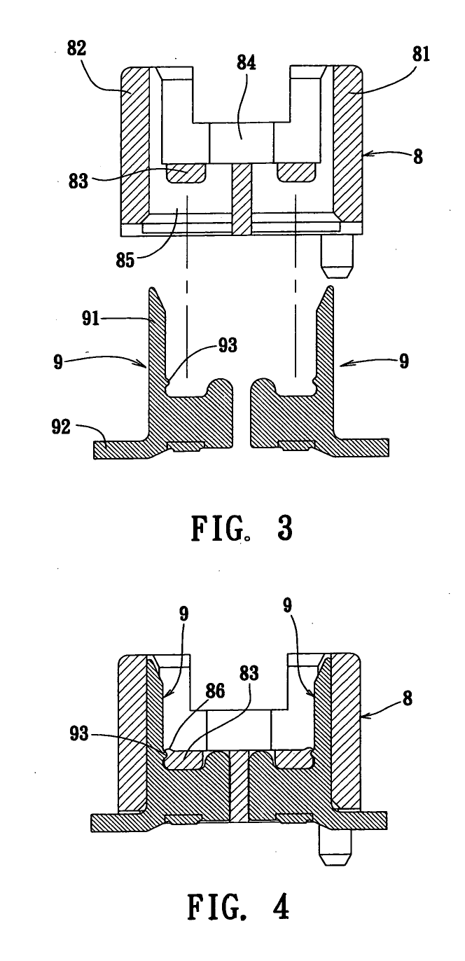

### DETAILED DESCRIPTION OF THE PREFERRED EMBODIMENT

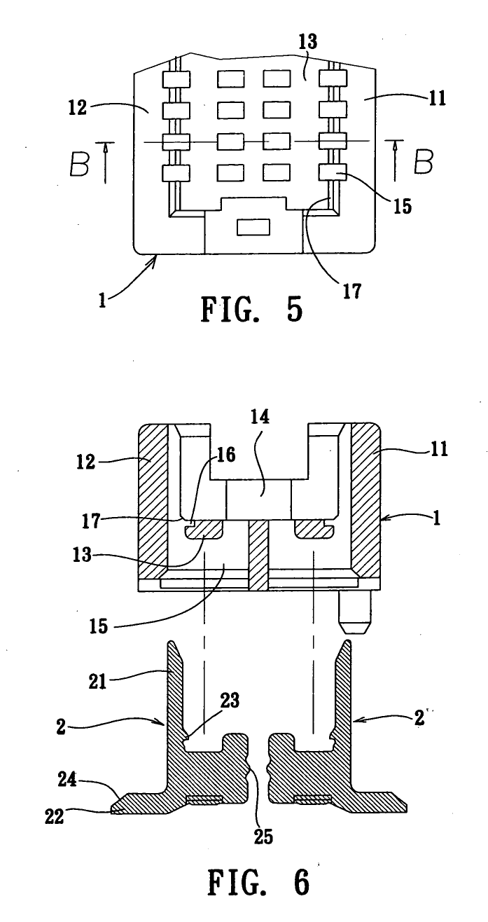

Referring to FIGS. 5˜7, an electric connector in accordance with the present invention is shown comprising an elongated electrically insulative housing 1 and a plurality of terminals 2 mounted in the housing 1.

The housing 1 has a first sidewall 11, a second sidewall 12, a bottom wall 13, a recessed receiving portion 14 surrounded by the sidewalls 11 and 12 and the bottom wall 13 and adapted to accommodate a matching connector, and a plurality of terminal slots 15, each of which is cut through the bottom wall 13 and extended to either the sidewall 11 or the sidewall 12 for receiving the terminals 2. The terminals 2 are respectively mounted in the terminal slots 15, each having a contact end 21 extended to one sidewall 11 or 12 and facing the recessed receiving portion 14, a bonding end 22 downwardly extended out of the bottom wall 13 for soldering to a circuit board (not shown), and a protruding positioning portion 23 suspended below the contact end 21 and projecting toward the recessed receiving portion 14 for positioning in the bottom wall 13 of the housing 1. Further, the housing 1 has a plurality of recessed retaining holes 16 in the bottom wall 13 corresponding to the protruding positioning portions 23 of the terminals 2. After installation of the terminals 2 in the terminal slots 15, the protruding positioning portions 23 of the terminals 2 are respectively engaged into the recessed retaining holes 16 in the bottom wall 13 of the housing 1. Therefore, installation of the terminals 2 in the terminal slots 15 of the housing 1 does not cause the plastic material of the housing 1 to deform.

Further, the joint between the sidewalls 12 and 13 and the bottom wall 13 is not a right-angle corner. Instead, a reinforcing wall portion 17 is formed integral with the housing 1 between the sidewalls 12 and 13 and the bottom wall 13 to reinforce the structural strength of the housing 1, preventing breaking of the plastic material of the housing 1 during installation.

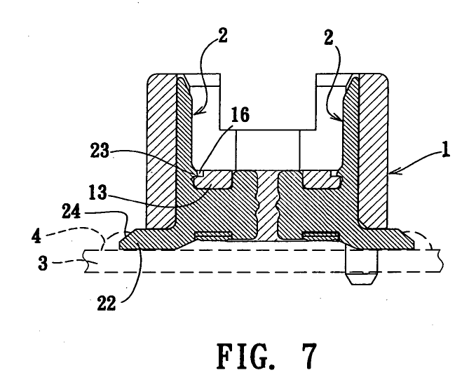

The terminals 2 each further comprise a friction portion 25. After installation of the terminals 2 in the respective terminal slots 15, the friction portions 25 are maintained in frictional contact with the periphery of the terminal slots 15, enhancing the positioning of the terminals 2 in the terminal slots 15. The bonding end 22 of each terminal 2 has a bevel edge 24, as shown in FIG. 7, so that the contact area between the bonding end 22 and the solder 4 is relatively increased, enhancing the tightness of the connection between the electric connector and the circuit board 3.

A prototype of electric connector for board-to-board connection has been constructed with the features of FIGS. 5˜7. The electric connector for board-to-board connection functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. An electric connector for board-to-board connection comprising:
an electrically insulative housing, said electrically insulative housing comprising a first sidewall, a second sidewall, a bottom wall joined to said first sidewall and said second sidewall at a bottom side, a recessed receiving portion surrounded by said sidewalls and said bottom wall and adapted to accommodate a matching connector, a first row of terminal slots, each of which is formed through said bottom wall and extended to said first sidewall, and a second row of terminal slots, each of which is formed through said bottom wall and extended to said second sidewall; and
a plurality of terminals respectively mounted in said first row and second row of terminal slots, said terminals each having a contact end extended to either said first sidewall or said second sidewall and facing said recessed receiving portion, a bonding end downwardly extended out of said bottom wall for soldering to a circuit board, and a protruding positioning portion suspended below said contact end and projecting toward said recessed receiving portion for positioning in said bottom wall of said housing;
wherein said housing has a plurality of recessed retaining holes in said bottom wall adapted to receive the protruding positioning portions of said terminals.

2. The electric connector as claimed in claim 1, wherein the joint between said first sidewall and said bottom wall is not a right-angle corner, and a reinforcing wall portion is formed integral with said housing between said first sidewall and said bottom wall to reinforce the structural strength of said housing.

3. The electric connector as claimed in claim 1, wherein the joint between said second sidewall and said bottom wall is not a right-angle corner, and a reinforcing wall portion is formed integral with said housing between said second sidewall and said bottom wall to reinforce the structural strength of said housing.

4. The electric connector as claimed in claim 1, wherein the bonding end has a bevel edge for enhanced soldering to the circuit board.
